(19) United States
(12) Patent Application Publication
(10) Pub. No.: US 2003/0065609 A1
(43) Pub. Date: Apr. 3, 2003

(54) Method and system for providing real-time data transmission for securities trading

(76) Inventor: KyongKun Oh, Chicago, IL (US)

Correspondence Address: JACKSON & CO., LLP, 6114 LA SALLE AVENUE, SUITE 507, OAKLAND, CA, 94611-2802, US

(21) Appl. No.: 09/967,076

(22) Filed: Sep. 28, 2001

(51) Int. Cl. G06F 17/60

(52) U.S. Cl. 705/37

(57) ABSTRACT

Method and system for providing real time commodity price communication via the Internet such that the transmitted information is automatically refreshed on the traders' stations when the prices are entered from a remote input station, where the web application may use a combination of server-side PUSH technology combined with one of ActiveX controls and Java applets on the client-side is provided.

### BACKGROUND OF THE INVENTION

The present invention relates to method and system for providing real time data transmission. More specifically, the present invention relates to a method and system for providing commodities trading using real-time data transmitted over the internet using server-side PUSH technology combined with client-side ActiveX control or a Java applet.

In commodities trading, acquiring the latest price of a commodity as soon as it has been established is valuable. Given that the price of a particular commodity fluctuates constantly, it is important for commodities traders to communicate information as pertaining to the price of the underlying commodities (as well as the volume of a particular transaction) on a frequent basis. Presently, most long distance price updates among commodities traders are conducted over the telephone where one person constantly relays the information to his or her trading partners as the prices are updated. This approach has numerous drawbacks. First, the relayed information is not transmitted in a truly real-time manner, second, the prices maybe falsely relayed due to communication errors by persons handling the information transmission (for example, misunderstanding a trader's voice), and third, unlike the data transmission over the Internet, long-distance phone calls are expensive.

Therefore, it would be advantageous to provide a web application provided for commodities traders which may be used to view prices on their terminals such as computer screens that is automatically updated or refreshed as soon as another party enters the information from a remote site, connected by the Internet. The web application in one embodiment may be programmed such that only the updated information is refreshed on the viewers' screen and not the entire web page.

### SUMMARY OF THE INVENTION

In view of the foregoing, the present invention provides a method and system of communicating commodity prices in real-time via the Internet such that the transmitted data are automatically refreshed on the viewers' stations (at the receiving end of the transmission, for example) as soon as the values are entered from a remote input station.

A system for providing real time data transmission of one embodiment includes a data network, a data provider coupled to the data network, the data provider configured to transmit real time data, a client terminal coupled to the data network, a server terminal coupled to the data network, the server terminal configured to receive the real time data from the data provider, the server terminal further configured to detect a connection request from the client terminal via the data network, and to establish a connection with the client terminal, wherein the server terminal is configured to push the received real time data substantially immediately to the connected client terminal.

The server terminal, the client terminal and the data terminal may each connected to the data network under TCP/IP protocol. The client terminal may one of a personal computer, a wireless application protocol (WAP) enabled mobile telephone, an internet access enabled personal digital assistant (PDA), and a laptop computer.

Moreover, the real time data includes one of a real time price information of a traded commodity, and a real time trade volume information of the traded commodity.

Further, the client terminal may be coupled to the data network under a secure environment, where the secure environment may include one of a password protected or an encrypted environment.

Additionally, the server terminal may be coupled to the data network in a secure environment, where the secure environment may include one of a password protected or an encrypted environment.

A method of another embodiment includes establishing a connection to a data provider, establishing a connection to a client terminal, transmitting a client receiver application to the connected client terminal, and pushing information received from the connected data provider substantially in real time to the connected client terminal.

The method may further include the step of displaying the pushed information at the client terminal.

Moreover, the step of establishing a data provider connection may include the step of establishing a TCP/IP communication protocol with the data provider, while the step of establishing a client terminal connection may include the step of establishing a TCP/IP communication protocol with the client terminal.

Additionally, the method in a further embodiment may include the step of receiving information from the connected data provider, where the received information may include a real time price information of a traded commodity.

A program storage device readable by a machine, tangibly embodying a program of instructions executable by the machine to perform a method for providing real time information of yet a further embodiment includes the steps of establishing a connection to a data provider, establishing a connection to a client terminal, transmitting a client receiver application to the connected client terminal, and pushing information received from the connected data provider substantially in real time to the connected client terminal.

The web application may be configured to use a combination of server-side PUSH technology (for example, where the server terminal is configured to push out the data received from the input station to all viewer stations) combined with either ActiveX controls or Java applets on the client-side. Since this is a web application, viewers will be able to view the data in real-time via a web browser such as Internet Explorer or Netscape Navigator by going to a designated web site. Furthermore, the data provider will be able to relay the data in real-time via a web browser such as Internet Explorer or Netscape Navigator by going to the designated web site. In a further embodiment, the web site may be password protected. Because the medium of transmission is the Internet, viewers, data provider, and the server terminal may all reside in separate, remote locations as long as they are connected to the Internet.

These and other features and advantages of the present invention will be understood upon consideration of the following detailed description of the invention and the accompanying drawings.

### BRIEF DESCRIPTION OF THE DRAWING

FIG. 1 is a block diagram of the overall system for providing real time data transmission for securities trading of one embodiment; and

FIG. 2 is a flowchart of real-time data transmission of the system of FIG. 1.

### DETAILED DESCRIPTION OF THE INVENTION

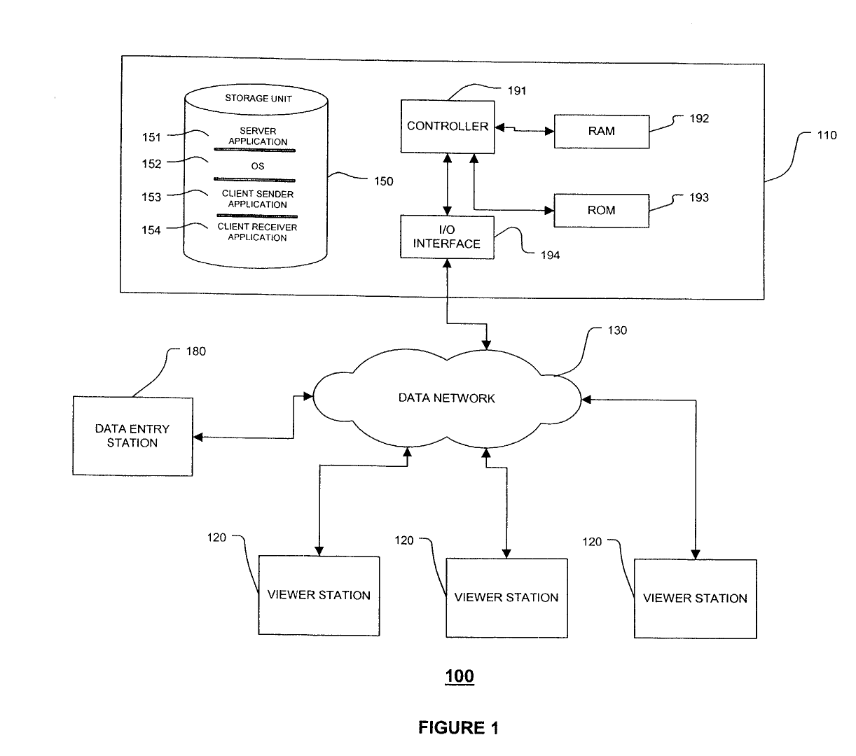

FIG. 1 is a block diagram of the overall system for providing real time data transmission for securities trading of one embodiment. Referring to FIG. 1, the overall system 100 includes a server terminal 110, a data entry station 180, a plurality of viewer stations 120, and a communication (data) network 130. As can be further seen from the Figure, the server terminal 110 includes a controller 191, a random access memory (RAM) 192, a read-only memory (ROM) 193, an input/output (I/O) interface 194, and a storage unit 150. Moreover, the storage unit 150 of the server terminal 110 may be configured to include, among others, a server application 151, an operating system (OS) 152, a client sender application 153, and a client receiver application 154.

Additionally, within the scope of the present invention, the storage unit may be configured to store additional applications and/or data which, under the control of the controller 191, may be accessed, updated, and the like. Indeed, in one embodiment, the controller 191 is configured to control application program operation by, for example, accessing and retrieving the respective application program from the storage unit 150. The controller 191 is further configured to access the RAM 192 and the ROM 193 to access and retrieve stored data therein. In one aspect, the RAM 192 may be configured to store information received by the server terminal 110 during a single of a multiple communication sessions to allow fast refresh and access time by the controller 191. Moreover, the ROM 193 may be configured to store data corresponding to the server terminal 110 or a given communication session or viewer station 120.

The I/O interface 194 is configured to connect to the data network 130 for receiving and transmitting information from and to the viewer stations 120 and the data entry station 180. Indeed, the I/O interface 194 may include one or more communication terminals configured to connect to data networks such as an infrared communication port, a USB port, a Bluetooth port, a IEEE 1394 (Firewire) communication port, a serial or a parallel port, each configured to establish a compatible data exchange protocol for communicating with one or more of the viewer stations 120 connected to the server terminal 110 via the data network 130. The controller 191 of the server terminal 110 may be configured to detect the connection of one or more of the viewer stations 120, receive a connection signal from the I/O interface 194, and accordingly, access the storage unit 150to retrieve and load corresponding driver applications to establish data communication with the external device.

Referring again to FIG. 1, the applications stored in the storage unit 150 may be embodied as computer programs developed using an object oriented language that allows the modeling of complex systems with modular objects to create abstractions that are representative of real world, physical objects and their interrelationships. However, it would be understood by one of ordinary skill in the art that the various embodiments as described herein may be implemented in many different ways using a wide range of programming techniques as well as general purpose hardware systems or dedicated controllers.

Referring again to FIG. 1, in an alternate embodiment, the server terminal 110 comprises a device connected to the data network 130, such as a general purpose processor operating under control of operating system and application software, and programmed to respond to messages from the viewer stations 130, and data entry station 180. In one embodiment, the server terminal 110 may include an Internet Information Server (IIS 4.0) operating under control of Microsoft NT Server (NT 4.0) operating system.

Since the server terminal 110 is connected to the data network 130, the server terminal 110 may have a specified IP (Internet Protocol) address that uniquely identifies it on the Internet such as the data network 130. Along with the IP address, the server terminal 110 may also be uniquely identified by a domain name such as www.omdstudio.com, and there may be a one-to-one correlation between the IP address and the domain name.

The server application 151 of the storage unit 150 of the server terminal 110 may, in one embodiment, be written in an object-oriented programming language such as Visual Basic, C++, or Java. In the case where the server application 151 is programmed in Java, it may be referred to as a Java Servlet. Alternatively, in the case where the server application is programmed in Visual Basic or C++, it may be referred to as a COM (Component Object Model). In one embodiment, the server application 151 may be written in Visual Basic as a COM. The server application 151 may handle the connection of the data entry station 180 to the viewer stations 120 via the data network 130, and also handle the storage of the received data in the storage unit 150 under the control of the controller 191.

In one embodiment, the storage unit 150 may include Microsoft SQL, but any relational database such as Microsoft Access, Oracle, Sybase, DB2, Informix, or non-relational database would be equally suitable. The client sender application 153 and the client receiver application 154 may also be written in Visual Basic, C++, or Java. If the client sender application 153 and the client receiver application 154 are written in Java, then they may be referred to as Java applets, and further, if written in Visual Basic or C++, they may be referred to as ActiveX controls. Java applets and ActiveX controls are computer programs that may be embedded into HTML pages to extend the functionality of web pages. In a further embodiment, the client sender application 153 and the client receiver application 154 may be written in Visual Basic and embedded into HTML pages as ActiveX controls.

When a data provider visits the appropriate web page of the specified web site, the client sender application 153 is automatically downloaded to the data entry station 180, and connects to the server application 151 in the server terminal 110. More specifically, the client sender application 153 is responsible for making a connection with the server terminal 110, and for transmitting the data to the server terminal 110 in real-time as they are entered in the data entry station 180. When a viewer (using one of the viewer stations 120) visits the appropriate web page of the specified web site, the client receiver application 154 is automatically downloaded onto the viewer station, and connects to the server application 151 in the server terminal 110. Indeed, the client receiver application 154 is responsible for making a connection with the server terminal, and receiving data in real-time as they are sent by the server terminal.

Referring back to FIG. 1, the data entry station 180 may include a computer terminal connected to the data network 130 such as a general purpose processor operating under control of operating system and application software. In one embodiment, the data entry station 180 may include a PC workstation with an Intel Pentium processor under control of Microsoft Windows 200/98/95/NT. The data entry station 180 may be configured to connect to the data network 130 via a web browser such as Internet Explorer or Netscape Navigator and to transmit data using the TCP/IP Internet protocol to the specified IP address of the server terminal 110.

In the appropriate web page of the data entry station 180 is embedded the client sender application 153 that originally resides on the server terminal 110, but is downloaded onto the data entry station 180 upon request by the data provider. The embedded client sender program 153 may then transmit the entered data via the data network 130 to the server application 151 in the server terminal 110, which pushes out the data to all viewer stations 120 in real-time.

Referring back to FIG. 1, each of the viewer stations 120 may comprise a device or set of devices coupled to the data network 130 such as a general purpose processor operating under control of operating system and application software. In one embodiment, the viewer stations 120 may include PC workstations using Intel Pentium processors operating under Microsoft Windows 2000/95/98/NT operating system. The viewer stations 120 may be configured to connect to the Internet (or the data network 130) using a web browser such as Internet Explorer or Netscape Navigator and receive data from the server terminal 110 by using the TCP/IP Internet Protocol.

When viewers use the web browser on the viewer stations 120 to visit the specified IP address or domain name of the server terminal 110, the client receiver application 154 is automatically downloaded onto the viewer stations, and display the data on the screen as they are sent out by the server application 151 on the server terminal 110 in real-time.

Referring again to FIG. 1, the data network 130 may be configured to provide for a communication channel between the data entry station 180 and the viewer stations 120 using the Internet Protocol TCP/IP. The actual physical connections may include fiber optic cables, T1 lines, or twisted copper pair telephone lines. In one embodiment, the twisted copper pair telephone lines may be used due to their existing infrastructure and cost effective deployment.

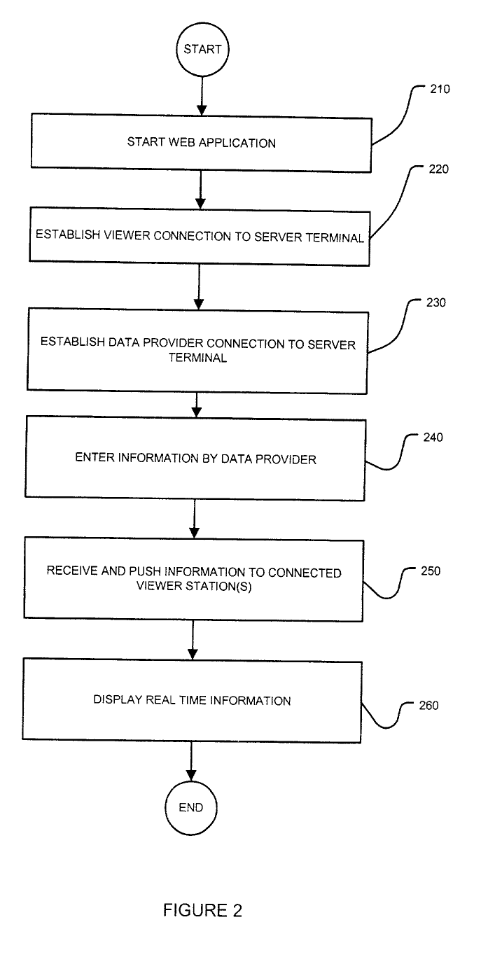

FIG. 2 is a flowchart of real-time data transmission of the system of FIG. 1. Referring to FIG. 2, at step 210, the web application is loaded and initiated on the server terminal 110 that is already connected to the data network 130 with a specified IP address and domain name. The web application may include the server application 151, client sender application 153, and client receiver application 154, each operating under the operating system (OS) environment. Thereafter at step 220, the server application 151 that is connected to the data network 130 monitors the data network 130 via, for example, I/O interface 194 for data transmission from the data entry station 180 and viewer stations 120. Then, the viewers using viewer stations 120 establish connection to the server terminal 110 via the data network 130 by visiting the appropriate web page of the designated web site, and automatically download the client receiver application 154 from the server terminal 110 onto their viewer stations 120. The client receiver application downloaded from the server terminal 110 onto the respective viewer stations 120 then establishes a connection to the server application 151 in the server terminal 110 via the data network 130, and awaits for data transmission from the server application 151.

Referring again to FIG. 2, at step 230 the data provider establishes connection to the server terminal 110 via the data network 130 by, for example, visiting the appropriate web page of the designated web site, and automatically downloads the client sender application 153 from the server terminal 110 into the data entry station 180. The downloaded client sender application 153 then makes a connection to the server application 151 on the server terminal 110 via the data network 130.

Thereafter, at step 240, the data provider enters commodity prices onto the appropriate input fields on the web site via the web browser, which are then automatically transmitted to the server application 151 on the server terminal 110 via the data network 130 in real-time. At step 250, when the server application 151 at the server terminal 110 receives the information transmitted from the data entry station 180, the server terminal is configured to store the received information in storage unit 150, and then to push the received information out to all the client receiver applications 170 resident on all the viewer stations 120 that are connected to the server application 151 of the server terminal 110. Then, at step 260, when the viewer stations 120 receive the incoming data, the appropriate value is automatically updated and displayed on the viewers' computer screens.

In the manner described above, in accordance with the various embodiments of the present invention, there is provided a method and system of communicating commodity prices in real-time via the Internet such that the transmitted data are automatically refreshed on the traders' stations (at the receiving end of the transmission, for example) as soon as the values are entered from a remote input station. The web application may be configured to use a combination of server-side PUSH technology (for example, where the server terminal is configured to push out the data received from the input station to all viewer stations) combined with either ActiveX controls or Java applets on the client-side. Since this is a web application, viewers will be able to view the data in real-time via a web browser such as Internet Explorer or Netscape Navigator by going to a designated web site. Furthermore, the data provider will be able to relay the data in real-time via a web browser such as Internet Explorer or Netscape Navigator by going to the designated web site. Moreover, the web site may be password protected. Because the medium of transmission is the Internet, viewers, data provider, and the server terminal may all reside in separate, remote locations as long as they are connected to the Internet.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A system for providing real time data transmission, comprising:
a data network;
a data provider coupled to the data network, the data provider configured to transmit real time data;
a client terminal coupled to the data network;
a server terminal coupled to the data network, the server terminal configured to receive the real time data from the data provider, the server terminal further configured to detect a connection request from the client terminal via the data network, and to establish a connection with the client terminal;
wherein the server terminal is configured to push the received real time data substantially immediately to the connected client terminal.

2. The system of claim 1 wherein the server terminal, the client terminal and the data terminal are each connected to the data network under TCP/IP protocol.

3. The system of claim 1 wherein the client terminal includes one of a personal computer, a wireless application protocol (WAP) enabled mobile telephone, an internet access enabled personal digital assistant (PDA), and a laptop computer.

4. The system of claim 1 wherein the real time data includes one of a real time price information of a traded commodity, and a real time trade volume information of the traded commodity.

5. The system of claim 1 wherein the client terminal is coupled to the data network under a secure environment.

6. The system of claim 5 wherein the secure environment includes one of a password protected or an encrypted environment.

7. The system of claim 1 wherein the server terminal is coupled to the data network in a secure environment.

8. The system of claim 7 wherein the secure environment includes one of a password protected or an encrypted environment.

9. A method, comprising:
establishing a connection to a data provider;
establishing a connection to a client terminal;
transmitting a client receiver application to the connected client terminal; and
pushing information received from the connected data provider substantially in real time to the connected client terminal.

10. The method of claim 9 further including the step of displaying the pushed information at the client terminal.

11. The method of claim 9 wherein the step of establishing a data provider connection includes the step of establishing a TCP/IP communication protocol with the data provider.

12. The method of claim 9 wherein the step of establishing a client terminal connection includes the step of establishing a TCP/IP communication protocol with the client terminal.

13. The method of claim 9 further including the step of receiving information from the connected data provider.

14. The method of claim 13 wherein the received information includes a real time price information of a traded commodity.

15. A program storage device readable by a machine, tangibly embodying a program of instructions executable by the machine to perform a method for providing real time information, said method comprising the steps of:
establishing a connection to a data provider;
establishing a connection to a client terminal;
transmitting a client receiver application to the connected client terminal; and
pushing information received from the connected data provider substantially in real time to the connected client terminal.
